(19) United States
(12) Patent Application Publication
(10) Pub. No.: US 2015/0291473 A1
(43) Pub. Date: Oct. 15, 2015

(54) ENERGY PREPARATION OF CERAMIC FIBER FOR COATING

(71) Applicant: United Technologies Corporation, Hartford, CT (US)

(72) Inventor: Wayde R. Schmidt, Pomfret Center, CT (US)

(21) Appl. No.: 14/639,390

(22) Filed: Mar. 5, 2015

Related U.S. Application Data
(60) Provisional application No. 61/977,160, filed on Apr. 9, 2014.

(51) Int. Cl. C03C 25/12; B05D 3/06; C03C 25/48; B05D 3/14

(52) U.S. Cl. CPC C03C 25/12; B05D 3/145; B05D 3/06; C03C 25/48

(57) ABSTRACT

A method of coating a fiber for forming a ceramic matrix composite material comprises the steps of moving a fiber through an energy application station, and applying energy to the fiber, and providing an outer coating on the fiber.

### CROSS-REFERENCE TO RELATED APPLICATION

This application claims priority to U.S. Provisional Patent Application No. 61/977,160, filed Apr. 9, 2014.

### BACKGROUND OF THE INVENTION

This application relates to a method of preparing a ceramic fiber for a subsequent coating, wherein the fiber is treated from an energy source.

Ceramic, carbon and glass fibers are utilized in the formation of ceramic matrix composites (“CMC”) materials. CMC materials are finding applications in any number of high temperature uses. As an example, gas turbine engines may incorporate a number of components formed of CMC materials.

The CMC materials are formed from ceramic, carbon or glass fibers, such as silicon carbide (“SiC”) fibers. In the formation of CMC materials, the diameter of the fibers may be between 5 and 150 microns. In the process of making the CMC materials, it is often desirable to coat the SiC fibers with one or more coatings. These coatings could include boron nitride or other coatings, such as silicon nitride, silicon carbide, boron carbide, carbon, oxides or combinations thereof to improve the environmental durability of the underlying materials.

It is known that application of a plasma treatment to ceramic fibers can increase their strength and some other properties. However, such a pretreatment has not been proposed to better improve the coatability of the fibers.

### SUMMARY OF THE INVENTION

In a featured embodiment, a method of coating a fiber for forming a ceramic matrix composite material comprises the steps of moving a fiber through an energy application station, and applying energy to the fiber, and providing an outer coating on the fiber.

In another embodiment according to the previous embodiment, the energy application station includes a plasma treatment.

In another embodiment according to any of the previous embodiments, the energy application station also includes a microwave application.

In another embodiment according to any of the previous embodiments, the energy application station includes a microwave application.

In another embodiment according to any of the previous embodiments, the fiber is a silicon-containing fiber.

In another embodiment according to any of the previous embodiments, the fiber has a diameter greater than or equal to 5 micron and less than or equal to 150 micron.

In another embodiment according to any of the previous embodiments, an outer coating on the fiber is provided after a fiber moves through an energy application station.

In another embodiment according to any of the previous embodiments, an outer coating on the fiber is provided while a fiber moves through an energy application station.

In another embodiment according to any of the previous embodiments, an outer coating on the fiber is provided before a fiber moves through an energy application station.

In another embodiment according to any of the previous embodiments, the fiber having a diameter greater than or equal to 5 micron and less than or equal to 150 micron.

In another embodiment according to any of the previous embodiments, an outer coating on the fiber is provided after a fiber moves through an energy application station.

In another embodiment according to any of the previous embodiments, an outer coating on the fiber is provided while a fiber moves through an energy application station.

In another embodiment according to any of the previous embodiments, an outer coating on the fiber is provided before a fiber moves through an energy application station.

In another embodiment according to any of the previous embodiments, the coating includes at least one of boron nitride, silicon nitride, silicon carbide, boron carbide, carbon, Si₃N₄, SiC, AlN, oxide coatings or combinations thereof.

In another embodiment according to any of the previous embodiments, an outer coating on the fiber is provided after a fiber moves through an energy application station.

In another embodiment according to any of the previous embodiments, an outer coating on the fiber is provided while a fiber moves through an energy application station.

In another embodiment according to any of the previous embodiments, an outer coating on the fiber is provided before a fiber moves through an energy application station.

In another embodiment according to any of the previous embodiments, the fiber is made into an intermediate product, and then into a final CMC component.

In another embodiment according to any of the previous embodiments, the final CMC component is for use in a gas turbine engine.

In another embodiment according to any of the previous embodiments, the coating includes at least one of boron nitride, silicon nitride, silicon carbide, boron carbide, carbon, Si₃N₄, SiC, AlN, oxide coatings or combinations thereof.

These and other features may be best understood from the following drawings and specification, the following of which is a brief description.

### BRIEF DESCRIPTION OF THE DRAWINGS

FIG. 1A schematically shows one method of a treatment of a ceramic fiber.

FIG. 1B shows another embodiment.

FIG. 2 shows an intermediate product.

FIG. 3 schematically shows a final product.

FIG. 4A shows another method embodiment.

FIG. 4B shows yet another method embodiment.

### DETAILED DESCRIPTION

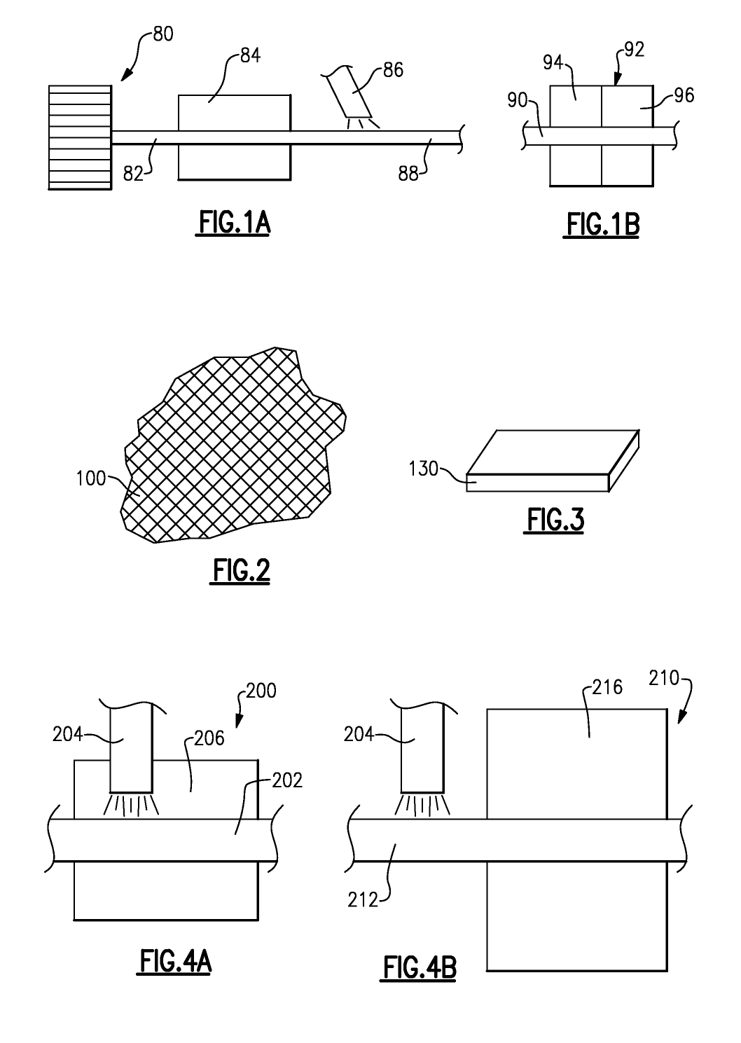

As shown in FIG. 1A, a spool 80 may include a fiber 82. The fiber may be a ceramic containing silicon, such as SiC, SiCO, SiCNO, SiBCN, Si₃N₄. Also, the fiber can be a ceramic without silicon, a carbon fiber, or an oxide fiber. Examples include boron carbide, carbon, aluminum oxide, mullite, zirconia, alumina-silicate glass and combinations thereof. The phase(s) of the fibers may be stoichiometric or non-stoichiometric. In addition, the fibers may be fully crystalline, fully amorphous or partially crystalline and partially amorphous.

Examples of such SiC fibers are available under the trade names Hi-Nicalon™ and Hi-Nicalon type S™. Such fibers may be available from Nippon Carbon Co, Ltd. (“NCK”) of Japan. Examples of ceramic oxide fibers are available under the trade name Nextel™ and may be procured from 3M™. The fiber 82 may be utilized to form CMC materials, and the fibers may be greater than or equal to 5 and less than or equal to 150 microns in diameter. Multiple fibers and fibers having a distribution of fiber diameters between 5 and 150 microns are also contemplated to benefit from this disclosure.

An energy application station or treatment 84 is shown applying energy to a pulled or drawn fiber. The fiber is then provided with a coating treatment 86, such that a downstream fiber portion 88 is coated. The application of the energy treatment increases the coatability of the fiber.

The coating treatment 86 is shown schematically as is the energy application station 84. The coating may be provided by a deposition process, or other appropriate coating processes including, but not limited to chemical vapor deposition, physical vapor deposition, dip coating, atomic layer deposition methods, spray coating, vacuum deposition or combinations thereof. Exemplary, but non limiting coatings may include boron nitride, silicon nitride, silicon carbide, boron carbide, carbon, Si₃N₄, SiC, AlN, oxide coatings or combinations thereof. The coatings themselves are known, however, the application of the energy treatment 84 increases the adherence and coatability to the fiber 82.

As shown in FIG. 1B, a fiber 90 is pulled through an energy application station 92 that includes two stations 94 and 96.

In various applications, the energy applied at station 84 (or stations 94 and 96) may include a plasma treatment or electromagnetic radiation, such as, but not limited to microwave, terahertz, radio, laser, ultraviolet, infrared or combinations thereof. The energy application will clean, functionalize, and create one or more reactive sites, such as unsaturated bonding, on the fiber surface that enhances the subsequent deposition of the coatings at station 86.

In various applications, the energy application will selectively and beneficially interact with the coating material prior to deposition, resulting in a more desirable coating phase or structure. In one non-limiting example, the coating material can be a precursor compound such as a volatile organometallic compound. When in the vapor state, an exemplary electromagnetic radiation source such as microwave energy can selectively interact with bonds in the organometallic compound, causing them to decompose, change or convert to another bond type. This resulting modified organometallic compound may be more desirable in producing the preferred coating composition or structure. In one example, the organometallic compound contains Si bonded to one or more non-metals (O, C, H, N, etc). After interaction with the microwave energy, the bond(s) can break, leaving behind a reactive silicon atom with incomplete bond saturation, which would selectively interact with the fiber surface.

While it has been proposed to utilize plasma treatment on ceramic fibers, this has not been to prepare the fibers for coating.

The FIG. 1B embodiment may be utilized with one of the stations 94 being microwave application and the other station 96 being plasma application.

The plasma treatment itself may be as known. The same is true of the microwave or other energy applications. The parameters for each of the treatments may be determined experimentally once a particular application has been identified.

FIG. 2 shows an intermediate product 100 which may be made from a fiber such as fiber 88. The intermediate product 100 may be a one, two or three dimensional product such as a fiber tow, pre-preg tape, woven cloths, knitted or braided or otherwise constructed volumes, such that a subsequent and final CMC product 130 (see FIG. 3) is formed. The intermediate product 100 may be subsequently utilized in a polymer infiltration and pyrolysis, a chemical vapor infiltration process and/or slurry cast melt information process to form the final CMC component 130. The component 130 formed in this way may be for use in a gas turbine engine, in one example, and could be a turbine blade, vane, blade outer air seal, combustion liner, etc.

The FIG. 1A/1B embodiment is not the only order of application of coating and energy within the scope of application.

As shown in FIG. 4A, in an embodiment 200, the coating treatment 204 is embedded into the energy treatment application 206. In this manner, the deposited coating on the fiber 202 can interact with the energy source to provide a set of benefits to the coating and the adhesion of the fiber.

FIG. 4B shows an embodiment 210 wherein the coating treatment 204 is applied to the fiber 212 before it enters the energy treatment station 216. In both the FIG. 4A and 4B embodiments, the coating material can be a precursor that can be converted to a more desirable phase in the final coating by the application of the energy.

Thus, if the energy application is considered a step (a) and the coating treatment considered a step (b), then the step (b) can occur after step (a), or the step (b) can occur during step (a), or the step (b) can occur before the step (a).

It should also be understood that while a single application of energy and coating is disclosed in this application, the coating and energy could be provided in an iterative manner. That is, there could be several coating and/or energy treatment stations.

Although an embodiment of this invention has been disclosed, a worker of ordinary skill in this art would recognize that certain modifications would come within the scope of this invention. For that reason, the following claims should be studied to determine the true scope and content of this invention.

1. A method of coating a fiber for forming a ceramic matrix composite material comprising the steps of:
(a) moving a fiber through an energy application station, and applying energy to the fiber; and
(b) providing an outer coating on said fiber.

2. The method as set forth in claim 1, wherein said energy application station includes a plasma treatment.

3. The method as set forth in claim 2, wherein said energy application station also includes a microwave application.

4. The method as set forth in claim 1, wherein said energy application station includes a microwave application.

5. The method as set forth in claim 1, wherein said fiber is a silicon-containing fiber.

6. The method as set forth in claim 5, wherein said fiber having a diameter greater than or equal to 5 micron and less than or equal to 150 micron.

7. The method as set forth in claim 5, wherein step (b) occurs after step (a).

8. The method as set forth in claim 5, wherein step (b) occurs during step (a).

9. The method as set forth in claim 5, wherein step (b) occurs before step (a).

10. The method as set forth in claim 1, wherein said fiber having a diameter greater than or equal to 5 micron and less than or equal to 150 micron.

11. The method as set forth in claim 10, wherein step (b) occurs after step (a).

12. The method as set forth in claim 10, wherein step (b) occurs during step (a).

13. The method as set forth in claim 10, wherein step (b) occurs before step (a).

14. The method as set forth in claim 1, wherein said coating includes at least one of boron nitride, silicon nitride, silicon carbide, boron carbide, carbon, Si₃N₄, SiC, AlN, oxide coatings or combinations thereof.

15. The method as set forth in claim 1, wherein step (b) occurs after step (a).

16. The method as set forth in claim 1, wherein step (b) occurs during step (a).

17. The method as set forth in claim 1, wherein step (b) occurs before step (a).

18. The method as set forth in claim 1, wherein said fiber is made into an intermediate product, and then into a final CMC component.

19. The method as set forth in claim 18, wherein said final CMC component is for use in a gas turbine engine.

20. The method as set forth in claim 19, wherein said coating includes at least one of boron nitride, silicon nitride, silicon carbide, boron carbide, carbon, Si₃N₄, SiC, AlN, oxide coatings or combinations thereof.
